(19) United States
(12) Patent Application Publication
(10) Pub. No.: US 2008/0305702 A1
(43) Pub. Date: Dec. 11, 2008

(54) Substrates Having Biocidal and/or Antimicrobial Properties

(75) Inventors: Edwin Nun, Billerbeck (DE); Heike Bergandt, Marl (DE); Andreas Gutsch, Ludinghausen (DE)

Correspondence Address: OBLON, SPIVAK, MCCLELLAND MAIER & NEUSTADT, P.C., 1940 DUKE STREET, ALEXANDRIA, VA, 22314, US

(73) Assignee: EVONIK DEGUSSA GMBH, Essen (DE)

(21) Appl. No.: 12/159,103

(22) PCT Filed: Nov. 24, 2006
(86) PCT No.: PCT/EP2006/068868

§ 371 Date: Jun. 25, 2008

(30) Foreign Application Priority Data
Jan. 11, 2006 (DE) 102006001641.6

(51) Int. Cl. B32B 7/10; B05D 3/02

(52) U.S. Cl. 442/71; 427/380

(57) ABSTRACT

The present invention relates to a method for coating substrates, comprising the steps:
a) provision of a substrate,
b) application of a composition to at least one side of the substrate, the composition containing an inorganic compound and the inorganic compound containing at least one metal and/or semi-metal selected from the group consisting of Sc, Y, Ti, Zr, Nb, V, Cr, Mo, W, Mn, Fe, Co, B, Al, In, Tl, Si, Ge, Sn, Zn, Pb, Sb, Bi or mixtures thereof and at least one element selected from the group consisting of Te, Se, S, O, Sb, As, P, N, C, Ga or mixtures thereof,
c) drying of the composition applied in step b),
d) application of at least one coating to the at least one side of the substrate on which the composition was applied in step b), the coating containing a silane of the general formula (Z¹)Si(OR)₃, where Z¹ is R, OR or Gly (Gly=3-glycidyloxypropyl) and R is an alkyl radical having 1 to 18 carbon atoms and all R may be identical or different, oxide particles which are selected from the oxides of Ti, Si, Zr, Al, Y, Sn, Zn, Ce or mixtures thereof, an initiator and optionally zinc, zinc salts, zinc complexes, silver, silver salts and/or complexed silver, and
e) drying of the coating applied in step d),
f) application of at least one further coating to the at least one side of the substrate on which the coating was applied in step d), the further coating containing a silane of the general formula (Z¹)Si(OR)₃, where Z¹ is R, OR or Gly (Gly=3-glycidyloxypropyl) and R is an alkyl radical having 1 to 18 carbon atoms and all R may be identical or different, an antimicrobial and/or biocidal substance selected from substances containing Zn, Zn salts, Zn complexes, such as, for example, zinc acetylacetonate, Zr, Ag, Ag salts, Ag complexes, Sn, Sn compounds or mixtures thereof, and an initiator, and
g) drying of the further coating applied in step f),
   and a substrate obtainable by the abovementioned method.

The present application relates to a method for coating substrates having biocidal properties, and substrates obtainable by the abovementioned method.

There is in the industry a need to reduce the growth of microbes or fungi on coverings, in particular on wall coverings, such as, for example, wallpapers. If a wall provided with a wallpaper is infested with mold, there is as a rule a very fast reaction owing to the visibility of the mold. Molds are fungi which populate the wall or other materials initially superficially and subsequently also in depth. Mold spots are individual, generally round colonies of fungi which have germinated from a single spore. From this researchers have distinguished about 10 000 species of mold, of which, however, only a few are found in living areas. If a wall is infested by mold, this infestation does not as a rule originate from a single species of fungi, but rather such a wall is populated by various species, Aspergillus and Penicillium species occurring most frequently.

In contrast to plants, fungi have no chlorophyll and therefore are not capable of obtaining their energy from sunlight. Wood and wood constituents, wall paints and plaster, flower pot earth and dead parts of indoor plants and foods serve as an energy source for fungi in the living area.

Fungi require water to grow. If water is absent, however, the fungus does not die immediately but forms so-called endospores. These endospores also enable the fungus to survive emergency periods and particular periods in which insufficient water is available. When growing conditions are favorable again, i.e. for example sufficiently moist conditions are present again, the fungus then grows if the “emergency period” was not sufficiently long to completely kill off the fungus. Thereafter, the fungus spreads and multiplies very rapidly through spores and conidia. The spores and conidia are produced in a very large number and are spread by floating in the air. They are invisible to the human eye and their diameter is on average from 0.002 to 0.006 mm. However, germination and fungal growth occur only if growth conditions favorable for the respective fungal species are present. Moist walls, for example, generally constitute an ideal living space and nutrient media for such fungi.

Molds require a temperature of about 20° C. and a relative humidity of more than 70% for growth. Examples of this are atmospheric humidity arising in the dwelling as a result of cooking, dishwashing, bathing, showering, washing or drying laundry or due to indoor plants and evaporation.

It is therefore of very great economic interest to reduce the consequences of mold infestation. In particular the occurrence of discolorations on infested areas by the so-called “spots” should be avoided. If such a spread of mold is not stopped in good time, wall coverings, such as, for example, wallpapers, are destroyed, wood or paper disintegrates and plaster and paints peel off.

Ceramic tiles constitute a poor nutrient medium for the molds, owing to the impenetrable surface. However, such ceramic tiles have the disadvantage that they are very brittle and are therefore of only limited suitability for lining walls. In the case of symmetrically very demanding surfaces in rooms, the tiles must be cut into appropriate shapes by a complicated procedure in order subsequently to be applied to a wall.

Furthermore, it is known that the use of, for example, silver or tin organyls suppresses the growth of fungi of any species. In this context, the prior art discloses a very wide range of methods for applying such biocidal and antimicrobial substances to the very wide range of substrates.

However, the substrate to which such an antimicrobial or biocidal coating is applied must withstand the reaction conditions of the application of the substances. Since as a rule an elevated temperature is required for applying, for example, silver to substrates, such methods of the prior art cannot be used, for example, for wallpapers which consist of a relatively thermally labile substrate, such as, for example, paper.

On the other hand, the prior art, for example Japanese laid-open application 11-323796, states that a wallpaper having antimicrobial properties can be obtained if silver-containing zeolite is applied. A disadvantage of this method, however, is that the zeolite, which was treated with silver, can be prepared only by a very expensive procedure.

The technical object of the present invention is to overcome the disadvantages of the prior art and in particular to provide a method for the preparation of a material provided with an antimicrobial and biocidal treatment, and this material itself, in which the proportion of antimicrobial and biocidal substance is reduced, the efficiency being improved and it being possible for the substrates used advantageously to be flexible substrates.

The technical object of the present invention is achieved by a method for coating substrates, comprising the steps:
a) provision of a substrate,
b) application of a composition to at least one side of the substrate, the composition containing an inorganic compound and the inorganic compound containing at least one metal and/or semi-metal selected from the group consisting of Sc, Y, Ti, Zr, Nb, V, Cr, Mo, W, Mn, Fe, Co, B, Al, In, Tl, Si, Ge, Sn, Zn, Pb, Sb, Bi or mixtures thereof and at least one element selected from the group consisting of Te, Se, S, O, Sb, As, P, N, C, Ga or mixtures thereof,
c) drying of the composition applied in step b),
d) application of at least one coating to the at least one side of the substrate on which the composition was applied in step b), the coating containing a silane of the general formula (Z¹)Si(OR)₃, where Z¹ is R, OR or Gly (Gly=3-glycidyloxypropyl) and R is an alkyl radical having 1 to 18 carbon atoms and all R may be identical or different, oxide particles which are selected from the oxides of Ti, Si, Zr, Al, Y, Sn, Zn, Ce or mixtures thereof, an initiator and optionally zinc, zinc salts, zinc complexes, silver, silver salts and/or complexed silver, and
e) drying of the coating applied in step d),
f) application of at least one further coating to the at least one side of the substrate on which the coating was applied in step d), the further coating containing a silane of the general formula (Z¹)Si(OR)₃, where Z¹ is R, OR or Gly (Gly=3-glycidyloxypropyl) and R is an alkyl radical having 1 to 18 carbon atoms and all R may be identical or different, an antimicrobial and/or biocidal substance selected from substances containing Zn, Zn salts, Zn complexes, such as, for example, zinc acetylacetonate, Ag, Ag salts, Ag complexes, Sn, Sn compounds or mixtures thereof, and an initiator, and
g) drying of the further coating applied in step f).

The method of the present invention is not limited to any specific substrates. The substrates may be both open-pore and closed-pore. The substrate in step a) can preferably be a flexible and/or rigid substrate. In a preferred embodiment, the substrate in step a) is a knitted fabric, a woven fabric, a braid, a film, a sheet-like structure, a nonwoven and/or a metal sheet. It is also preferable if the substrate is a paper substrate.

The substrate in step a) is preferably substantially thermally stable at a temperature greater than 100° C. In a more preferred embodiment, the substrate in step a) is substantially thermally stable under the drying conditions of steps c), e) and/or g). Substantially thermally stable is understood as meaning that the structure of the substrate does not change substantially and can therefore be used for the desired purpose.

In a preferred embodiment, the inorganic compound of step b) is selected from TiO₂, Al₂O₃, SiO₂, ZrO₂, Y₂O₃, BC, SiC, Fe₂O₃, SiN, SiP, aluminosilicates, aluminum phosphates, zeolites, partially exchanged zeolites or mixtures thereof. Preferred zeolites are, for example, ZSM-5, Na-ZSM-5 or Fe-ZSM-5 or amorphous microporous mixed oxides which may contain up to 20 percent of unhydrolyzable organic compounds, such as, for example, vanadium oxide-silica glass or alumina-silica-methylsilicon sesquioxide glasses.

Preferably, the inorganic compound of step b) has a particle size of from 1 nm to 10 000 nm, more preferably from 5 nm to 5000 nm, preferably from 10 nm to 2000 nm, in a more preferred embodiment from 10 nm to 1000 nm, preferably from 15 nm to 700 nm and most preferably from 20 nm to 500 nm.

It may be advantageous if the composite material according to the invention has at least two particle size fractions of the at least one inorganic compound. It may also be advantageous if the substrate according to the invention has at least two particle size fractions of at least two inorganic compounds. The particle size ratio may be from 1:1 to 1:10 000, preferably from 1:1 to 1:100. The ratio of the particle size fractions in the composition of step b) can preferably be from 0.01:1 to 1:0.01.

The composition of step b) is preferably a suspension, which is preferably an aqueous suspension. The suspension can preferably comprise a liquid selected from water, alcohol, acid or a mixture thereof.

The inorganic compound of step b) is preferably obtained by a hydrolysis of a precursor of the inorganic compound containing the metal and/or semi-metal. The hydrolysis can be effected, for example, by water and/or alcohol.

The precursor of the inorganic compound is preferably selected from metal nitrate, metal halide, metal carbonate, metal alcoholate, metal acetylacetonates, semi-metal halide, semi-metal alcoholate or a mixture thereof. Preferred precursors are, for example, titanium alcoholates, such as, for example, titanium isopropylate, silicon alcoholates, such as, for example, tetraethoxysilane, and zirconium alcoholates. Preferred metal nitrates are, for example, zirconium nitrate. In an advantageous embodiment, at least half the molar ratio of water, water vapor or ice is present in the composition with respect to the hydrolyzable precursor, based on the hydrolyzable group of the precursor.

The composition of step b) preferably contains an initiator which preferably hydrolyzes the inorganic precursor. In initiator can preferably also be an acid or base, an aqueous acid or base being more preferred. Moreover, the composition of step b) may be a sol.

In a preferred embodiment, the composition of step b) is a sol. In a preferred embodiment, it is possible to use commercially available sols, such as, for example, titanium nitrate sol, zirconium nitrate sol or silica sol.

The drying of the composition in step c) is preferably carried out by heating to a temperature of from 50° C. to 1000° C. In a preferred embodiment, drying is effected for from 1 minute to 2 hours at a temperature of from 50° C. to 100° C.

In another preferred embodiment, drying is effected in step c) for from 1 second to 10 minutes at a temperature of from 100° C. to 800° C.

The drying of step c) can be effected by means of heated air, hot air, infrared radiation, microwave radiation or electrically generated heat.

In a preferred embodiment, R in the general formula (Z¹)Si(OR)₃ of step d) and/or f) is an alkyl radical having 1, 2, 3, 4, 5, 6, 7, 8, 9, 10, 11, 12, 13, 14, 15, 16, 17 and/or 18 carbon atoms.

In a preferred embodiment, the coating of step d) and/or f) contains a second silane of the general formula (Z²)_{z}Si(OR)_{4-z}, where R is an alkyl radical having 1 to 8 carbon atoms and Z² is HₐF_{b}Cₙ, where a and b are integers, all R may be identical or different, a+b=1+2n, z is 1 or 2 and n is 1 to 16, or, where Z¹ is Gly, Z² is Am (Am=3-aminopropyl) with z=1. Preferably, n is 1, 2, 3, 4, 5, 6, 7, 8, 9, 10, 11, 12, 13, 14, 15 and/or 16. In a preferred embodiment, R in the general formula (Z²)Si(OR)₃ is an alkyl radical having 1, 2, 3, 4, 5, 6, 7, 8, 9, 10, 11, 12, 13, 14, 15 and/or 16 carbon atoms.

In a more preferred embodiment, the coating d) and/or f) contains 3-glycidyloxypropyltriethoxysilane and/or 3-glycidyloxypropyltrimethoxysilane as a silane and/or 3-aminopropyltrimethoxysilane and/or 3-aminopropyltriethoxysilane and/or N-2-aminoethyl-3-aminopropyltrimethoxysilane (DAMO) as the second silane.

It is also preferred if the coating of step d) and/or f) contains trimethoxysilane as a silane and a silane of the formula (HₐF_{b}Cₙ)_{z}Si(OR)_{4-z}, where a and b are integers, a+b=1+2n, z is 1 or 2, n is 1 to 16 and all R may be identical or different, preferably all R being identical and containing 1 to 6 carbon atoms, as the second silane.

More preferably, the coating of step d) and/or f) contains tetraethoxysilane, methyltriethoxysilane, octyltriethoxysilane and/or hexadecyltrimethoxysilane as a silane and/or 3,3,4,4,5,5,6,6,7,7,8,8,8-tridecafluorooctyltriethoxysilane as the second silane.

It is preferable if the coating of step d) and/or f) contains, as the initiator, an acid or base which is preferably an aqueous acid or base.

Moreover, the surface of the oxide particle present in the coating of step d) and/or f) may be hydrophobic. Organic radicals X₁₊₂ₙCₙ bonded to silicon atoms, where n is from 1 to 20 and X is hydrogen and/or fluorine, are preferably present on the surface of the oxide particles of the coating of step d) and/or f). The organic radicals may be identical or different. n is preferably 1, 2, 3, 4, 5, 6, 7, 8, 9, 10, 11, 12, 13, 14, 15, 16, 17, 18, 19 and/or 20. The groups bonded to silicon atoms are preferably methyl, ethyl, propyl, butyl, pentyl and/or octyl groups. In a particularly preferred embodiment, trimethylsilyl groups are bonded to the surface of the oxide particles. The organic radicals can preferably be eliminated and more preferably hydrolyzed.

The oxide particles of the coating of step d) and/or f) can be selected from the oxides of Ti, Si, Zr, Al, Y, Sn, Zn and Ce or may contain mixtures thereof. Preferably, the oxide particles of the coating of step d) and/or f) are partly hydrolyzed under the reaction conditions of step d) and/or f) on the surface of the oxide particles. Here, reactive centers which react with the organic silicon compounds of the coating of step d) and/or f) preferably form. These organic silicon compounds can be covalently bonded to the oxide particles by, for example, —O— bonds during the drying of step e) and/or g). As a result, the oxide particles are covalently crosslinked with the hardening coating. The layer thickness of the hardening coating can therefore surprisingly be further increased.

The oxide particles may have a mean particle size from 10 to 1000 nm, preferably from 20 to 500 nm, more preferably from 30 to 250 nm. If the coating is to be transparent and/or colorless, it is preferable to use only oxide particles which have a mean particle size of from 10 to 250 nm. The mean particle size relates to the particle size of the primary particles or, if the oxides are present as agglomerates, to the size of the agglomerates. The particle size is determined by light scattering methods, for example by means of an apparatus of the type HORIBA LB 550® (from Retsch Technology).

The coating of step d) and/or f) may contain, as a further constituent, a polymer which preferably has a mass average molecular weight of at least 3000 g/mol. Preferably, the average mass average molecular weight is at least 5000 g/mol, more preferably at least 6000 g/mol and most preferably at least 10 000 g/mol.

Preferably, the polymer present in the coating of step d) and/or f) has an average degree of polymerization of at least 50. In a more preferred embodiment, the average degree of polymerization is at least 80, more preferably at least 95 and most preferably at least 150. The polymer of the coating of step d) and/or f) can be selected from polyamide, polyester, epoxy resin, melamine/formaldehyde condensate, urethane/polyol resin or mixtures thereof.

It is preferable if, in step d), the coating is applied to the substrate in an amount such that a layer of the dried respective coating having a layer thickness of from 0.05 to 10 μm is present on the substrate after drying in step e). Preferably, a coating of step d) having a layer thickness of from 0.1 μm to 9 μm, more preferably from 0.2 μm to 8 μm and most preferably from 0.3 μm to 7 μm is present on the dried substrate.

Before the application of the coating in step b), d) and/or f), at least one additional coating can preferably be applied.

Alternatively, it is possible for at least one additional coating to be applied after the application of the coating in step b), d) and/or f).

In a preferred embodiment, the drying of the coating of step e) and/or g) is carried out by heating to a temperature of from 50° C. to 1000° C.

The drying of step e) and/or g) can be carried out by any method which is known to the person skilled in the art. In particular, the drying can be carried out in an oven. More preferably, the drying is carried out in a hot-air oven, forced-circulation oven, or microwave oven or by exposure to infrared radiation. In particular, the drying can preferably be carried out using the method and the drying times of step c).

In step f), the further coating is preferably applied to the substrate in an amount such that, after drying in step g), a layer of the dried further coating having a layer thickness of less than 1 μm, more preferably of from 5 to 600 nm, in particular of from 10 to 500 nm and most preferably of from 20 to 400 nm is present on the substrate.

In a preferred embodiment, the coating material of step f) contains a diluent. The diluent preferably further reduces the viscosity of the coating material of step f). The diluent can preferably be selected from aliphatic alcohols, aromatic alcohols, aliphatic ketones, aromatic ketones, aliphatic esters, aromatic esters, aliphatic hydrocarbons, aromatic hydrocarbons or mixtures thereof. Surprisingly, the homogeneity of the applied coating after drying is further improved by the diluent.

In a preferred embodiment, in the coating material of step d) and/or f), the antimicrobial and/or biocidal substance is selected from particulate silver, silver salts, complexed silver, zinc, zinc salts, complexed zinc or mixtures thereof.

The particulate silver in step d) or f) preferably has a mass average particle size of from 20 nm to 1000 nm, more preferably from 60 nm to 500 nm and most preferably from 80 nm to 250 nm.

In a more preferred embodiment, at least one further coating can be applied before the application of the coating in step b), d) and/or f). This further coating may be, for example, a print. Such a print can be applied by any printing method which is familiar to the person skilled in the art, in particular the offset printing method, flexographic printing method, pad printing or inkjet printing method.

In a further embodiment, at least one further coating can be applied after the application of the coating in step d) and/or f). This further coating is not limited and may be any coating which is known to the person skilled in the art. In particular, this coating may also be a print. In this case, too, the print can be applied by any method which is familiar to the person skilled in the art, in particular the offset printing method, flexographic printing method, pad printing and inkjet printing method.

By means of the abovementioned method, a coated substrate which is preferably a wallpaper is obtainable.

By means of the method of the present invention, it has been possible to provide a substrate provided with a biocidal and/or antimicrobial treatment, in which the number of antimicrobial or biocidal active substances is reduced. In particular, through the specific structure of the substrate, it has been possible to anchor the antimicrobial and/or biocidal substance on the surface layer, flexible substrates, such as, for example, wallpapers, being obtainable. It is surprising that, by means of the multilayer structure of the present invention, it is possible to produce flexible substrates in which the applied coating on curvature of the substrate around usually used radii no damage to the substrate occurs and in particular the biocidal and/or microbial action of the substrate is not reduced.

Coated substrates of the present invention surprisingly exhibit very high flexibility. If the substrate is flexible, the substrate can be bent without the applied coatings being destroyed or tearing. In particular, it is therefore possible to apply, to flexible tiles or wallpapers, coatings which adapt to the surface structure of a substrate without the coating being adversely affected. As already described, a very wide range of protective layers can be applied as the coating, in particular protective layers against aggressive chemicals or dirt-repellant coatings.

It is also surprising that the coated substrate of the present invention is resistant to washing and scouring (DIN EN 259).

1. A method for coating substrates, comprising the steps:
a) provision of a substrate,
b) application of a composition to at least one side of the substrate, the composition containing an inorganic compound and the inorganic compound containing at least one metal and/or semi-metal selected from the group consisting of Sc, Y, Ti, Zr, Nb, V, Cr, Mo, W, Mn, Fe, Co, B, Al, In, Tl, Si, Ge, Sn, Zn, Pb, Sb, Bi or mixtures thereof and at least one element selected from the group consisting of Te, Se, S, O, Sb, As, P, N, C, Ga or mixtures thereof,
c) drying of the composition applied in step b),
d) application of at least one coating to the at least one side of the substrate on which the composition was applied in step b), the coating containing a silane of the general formula (Z¹)Si(OR)₃, where Z¹ is R, OR or Gly (Gly=3-glycidyloxypropyl) and R is an alkyl radical having 1 to 18 carbon atoms and all R may be identical or different, oxide particles which are selected from the oxides of Ti, Si, Zr, Al, Y, Sn, Zn, Ce or mixtures thereof, an initiator and optionally zinc, zinc salts, zinc complexes, silver, silver salts and/or complexed silver, and
e) drying of the coating applied in step d),
f) application of at least one further coating to the at least one side of the substrate on which the coating was applied in step d), the further coating containing a silane of the general formula (Z¹)Si(OR)₃, where Z¹ is R, OR or Gly (Gly=3-glycidyloxypropyl) and R is an alkyl radical having 1 to 18 carbon atoms and all R may be identical or different, an antimicrobial and/or biocidal substance selected from substances containing Zn, Zn salts, Zn complexes, such as, for example, zinc acetylacetonate, Zr, Ag, Ag salts, Ag complexes, Sn, Sn compounds or mixtures thereof, and an initiator, and
g) drying of the further coating applied in step f).

2. The method according to claim 1, wherein the substrate in step a) is a flexible and/or rigid substrate.

3. The method according to claim 1, wherein the substrate in step a) is a knitted fabric, a woven fabric, a braid, a film, a sheet-like structure, a nonwoven and/or a metal sheet.

4. The method according to claim 1, wherein the substrate in step a) is substantially thermally stable at a temperature greater than 100° C.

5. The method according to claim 1, wherein the substrate in step a) is substantially thermally stable under the drying conditions of steps c), e) and (or) g).

6. The method according to claim 1, wherein the inorganic compound of step b) is selected from TiO₂, Al₂O₃, SiO₂, ZrO₂, Y₂O₃, BC, SiC, Fe₂O₃, SiN, SiP, aluminosilicates, aluminum phosphates, zeolites, partially exchanged zeolites or mixtures thereof.

7. The method according to claim 1, wherein the inorganic compound of step b) has a particle size from 1 nm to 10 000 nm.

8. The method according to claim 1, wherein the composition of step b) is a suspension which is preferably an aqueous suspension.

9. The method according to claim 1, wherein the inorganic compound of step b) is obtained by hydrolyzing a precursor of the inorganic compound containing the metal and/or semi-metal.

10. The method according to claim 9, wherein the precursor of the inorganic compound is selected from metal nitrate, metal halide, metal carbonate, metal alcoholate, metal acetylacetonate, semi-metal halide, semi-metal alcoholate or mixtures thereof.

11. The method according to claim 1, wherein the composition of step b) contains an initiator.

12. The method according to claim 11, wherein the initiator is an acid or base which is preferably an aqueous acid or base.

13. The method according to claim 1, wherein the composition of step b) is a sol.

14. The method according to claim 1, wherein the drying of the composition in step c) is carried out by heating to a temperature of from 50° C. to 1000° C.

15. The method according to claim 1, wherein the coating of step d) and/or f) contains a second silane of the general formula (Z²)_{z}Si(OR)_{4-z}, where R is an alkyl radical having 1 to 8 carbon atoms and Z² is HₐF_{b}Cₙ, where a and b are integers, all R may be identical or different, a+b=1+2n, z is 1 or 2 and n is 1 to 16, or, where Z¹ is Gly, Z² is Am (Am=3-aminopropyl) with z=1.

16. The method according to claim 1, wherein the coating of step d) and/or f) contains 3-glycidyloxypropyltriethoxysilane and/or 3-glycidyloxypropyltrimethoxysilane as a silane and/or 3-aminopropyltrimethoxysilane and/or 3-aminopropyltriethoxysilane and/or N-2-aminoethyl-3-aminopropyltriethoxysilane (DAMO) as the second silane.

17. The method according to claim 1, wherein the coating of step d) and/or f) contains tetraethoxysilane as a silane and a silane of the formula (HₐF_{b}Cₙ)_{z}Si(OR)_{4-z}, where a and b are integers, a+b=1+2n, z is 1 or 2, n is 1 to 16 and all R may be identical or different, all R preferably being identical and containing 1 to 6 carbon atoms, as the second silane.

18. The method according to claim 1, wherein the coating of step d) and/or f) contains tetraethoxysilane, methyltriethoxysilane, octyltriethoxysilane and/or hexadecyltrimethoxysilane as a silane and/or 3,3,4,4,5,5,6,6,7,7,8,8,8-tridecafluorooctyltriethoxysilane as the second silane.

19. The method according to claim 1, wherein the coating of step d) and/or f) contains, as the initiator, an acid or base which is preferably an aqueous acid or base.

20. The method according to claim 1, wherein the surface of the oxide particles present in the coating of step d) and/or f) is hydrophobic.

21. The method according to claim 1, wherein organic radicals X₁₊₂ₙCₙ bonded to silicon atoms, where n is from 1 to 20 and X is hydrogen or fluorine, are present on the surface of the oxide particles of the coating of step d) and/or f).

22. The method according to claim 1, wherein the coating of step d) and/or f) contains a polymer which preferably has an average mass average molecular weight of at least 3000 g/mol.

23. The method according to claim 22, wherein the polymer of the coating of step d) and/or f) has an average degree of polymerization of at least 50.

24. The method according to claim 22, wherein the polymer of the coating in step d) and/or f) is selected from polyamide, polyester, epoxy resins, melamine/formaldehyde condensate, urethane/polyol resin or mixtures thereof.

25. The method according to claim 1, wherein, in step d) and/or f), the coating is applied to the substrate in an amount such that, after drying in step e), a layer of the dried coating having a layer thickness of from 0.05 to 10 μm is present on the substrate.

26. The method according to claim 1, wherein at least one additional coating is applied before the application of the coating in step b), d) and/or f).

27. The method according to claim 1, wherein at least one additional coating is applied after the application of the coating in step b), d) and/or f).

28. The method according to claim 1, wherein the drying of the coating in step e) and/or g) is carried out by heating to a temperature of from 50° C. to 1000° C.

29. The method according to claim 1, wherein, in step f), the further coating is applied to the substrate in an amount such that, after drying in step g), a layer of the dried further coating having a layer thickness of less than 1 μm, is present on the substrate.

30. The method according to claim 1, wherein a diluent is present in the coating material of step f).

31. The method according to claim 30, wherein the diluent is selected from aliphatic alcohols, aromatic alcohols, aliphatic ketones, aromatic ketones, aliphatic esters, aromatic esters, aliphatic hydrocarbons, aromatic hydrocarbons, or mixtures thereof.

32. The method according to claim 1, wherein, in the coating material of step d) and/or f), the antimicrobial and/or biocidal substance is selected from particulate silver, silver salts, complexed silver, zinc, zinc salts, complexed zinc or mixtures thereof.

33. The method according to claim 32, wherein the particulate silver has a mass average particle size of from 20 nm to 1000 nm, more preferably from 60 nm to 500 nm and most preferably from 80 nm to 500 nm.

34. A coated substrate obtainable according to claim 1.

35. The substrate according to claim 34, wherein the coated substrate is a wallpaper.

36. The method of using the coated substrate according to claim 34 as wallpaper.
